(19) United States
(12) Patent Application Publication
(10) Pub. No.: US 2010/0091639 A1
(43) Pub. Date: Apr. 15, 2010

(54) OPTICAL RECORDING MEDIUM FOR PERFORMING SUPER RESOLUTION REPRODUCTION AND OPTICAL RECORDING AND REPRODUCTION METHOD THEREOF

(75) Inventors: Takayuki Shima, Tsukuba-shi (JP); Takashi Nakano, Tsukuba-shi (JP); Kazuma Kurihara, Tsukuba-shi (JP); Junji Tominaga, Tsukuba-shi (JP)

Correspondence Address: GREENBLUM & BERNSTEIN, P.L.C., 1950 ROLAND CLARKE PLACE, RESTON, VA, 20191, US

(73) Assignee: National Institute of advanced industrial Science and Technology, Tokyo (JP)

(21) Appl. No.: 12/516,492

(22) PCT Filed: Jul. 16, 2008
(86) PCT No.: PCT/JP2008/062809

§ 371 Date: May 27, 2009

(30) Foreign Application Priority Data
Sep. 21, 2007 (JP) 2007-245487

(51) Int. Cl. G11B 7/24

(52) U.S. Cl. 369/275.4; G9B/7

(57) ABSTRACT

The invention performs super resolution reproduction with a recording layer and a signal reproducing functional layer laminated on a grooved substrate. A length of a mark recorded in a Mark Position method is only one length that is less than the resolution limit in an optical system to be used, and recording marks are formed both on a land and in a groove of the grooved substrate.

### TECHNICAL FIELD

The present invention relates to an optical recording medium that reproduces information by irradiating laser light onto recording marks, in particular, to an optical recording medium having an additional structure for reproducing recording marks that are less than the resolution limit.

This application claims the priority of Japanese Patent Application No. 2007-245487, filed on Sep. 21, 2007, the contents of which are incorporated herein by reference.

### BACKGROUND ART

For example, an optical recording medium such as a digital video disc and a blu-ray disc is such that in a reproduction optical system with a laser light of wavelength λ and a numerical aperture NA of an objective lens, the length of a reproducible recording mark in recording mark sequence in which the length of the recording mark is equal to the length of an adjacent non-recorded space, is greater than or equal to the resolution limit (λ/4 NA). In such an optical recording medium, as a method of reproducing a recording mark of a length that is less than the resolution limit, there has been investigated a technique for practically increasing the NA within the medium by adding, to the optical recording medium, a signal reproducing functional layer having a function to reduce the size of a laser light spot.

As a result of performing super resolution reproduction, recording density in the medium tangential direction can be increased by two to four times. Therefore it becomes possible to increase the capacity per one recording layer of the optical recording medium by at least two to four times. For example, as shown in FIG. 1, when performing super resolution reproduction, within a laser light spot, there are a spot portion for performing super resolution reproduction, and the other peripheral portion. A recording mark that is less than the resolution limit is only reproduced in the super resolution spot portion, however, recording marks greater than the resolution limit are respectively reproduced in both of the super resolution spot portion and the peripheral portion.

If reproduction is to be performed in two portions within the laser light spot, unless the respective portions are coaxially present, a phase shift will occur, and in addition, reproduction waveforms will be observed in a state where two reproduction signals are superposed. That is to say, there will be required separate processing for appropriately separating these two signals. Actually this separation is not easy, and therefore in Patent Document 1 for example, there has been designed a film structure in which reproduction signals from the peripheral portion are not observed. Moreover, in Non-Patent document 1, the problem of separation is avoided by a method of learning a correlation between recording content and reproduction waveform.

However, the former is for a read-only type recording medium, and there has been no report of a recording material that realizes this on a recording type recording medium (write-once/read-many times and rewritable type). The latter assumes learning, and it therefore requires a new additional process for performing a test recording and a test reproduction. In this way it is possible in principle to increase the capacity of an optical recording medium by performing super resolution reproduction. However, there is a problem in that direct handling of an observed reproduction signal waveform is not sufficiently performed, and this is one of the reasons that a recordable optical recording medium for performing super resolution reproduction has not been brought into a practical application.

Incidentally, for optical magnetic recording, a recordable medium for performing super resolution reproduction has already been made commercially available. This recording medium, from a reproducing principle aspect, has a feature in that reproduction signals from the peripheral portion in FIG. 1 are not observed. Hence it does not have the above separation problem.

A recordable optical recording medium for performing super resolution reproduction, for example as disclosed in Non-Patent Document 2, Patent Document 2, and Patent Document 3, comprises a signal reproducing functional layer, a recording layer, a protective layer, and a reflecting layer that are formed on a grooved substrate. Due to laser light irradiation for reproduction, for example, the temperature of the signal reproducing functional layer rises, and as a result, within the laser light spot in FIG. 1, there emerges a super resolution spot portion that enables super resolution reproduction. The super resolution spot portion is formed, for example, due to melting or phase transition in a location on the signal reproducing functional layer where the temperature rises, and the optical constant thereof differs from that of the peripheral portion.

A recording mark with a length less than the resolution limit is only reproduced in the super resolution spot portion, and is not reproduced from the peripheral portion. That is to say, if the length of all recording marks is less than the resolution limit, the number of spots effectively will be one, and there will not be the problem where reproduction signal processing becomes complex when there are two spots present. However, in a method called Mark Edge, the length of the shortest recording mark is several fractions (for example, two-ninths) of the length of the longest recording mark. In an optical recording medium for performing super resolution reproduction, it is difficult, with practical sufficient performance, to reproduce the length of, for example, two-ninths of the resolution limit.

On the other hand, in a method called Mark Position, the length of a recording mark is only one, and therefore this may be set to less than the resolution limit. However, the capacity becomes 1/1.78 of that in the Mark Edge method, and therefore the advantage of performing super resolution reproduction is reduced.

Marks are frequently recorded either on a convex or in a concave surface (hereunder, referred to as a land and a groove) of the grooved substrate (refer to FIG. 2). However, if marks are recorded both on the land and in the groove (hereunder, referred to as land-and-groove recording), the capacity can be increased two-fold. In this case, the distance between recording mark sequences (hereunder, referred to as track pitch) becomes shorter. Consequently there is a problem in that superposition of reproduction signals from the adjacent recording mark sequence (hereunder, referred to as crosstalk) becomes more significant. For example, land-and-groove recording is performed in a standard called HD DVD-RAM. However, the track pitch is not a half of that in the case of only recording in the groove in the HD DVD-RW standard for example. That is to say, the capacity does not increase to two-fold.

[Patent Document 1] Japanese Unexamined Patent Application, First Publication No. H5-258345

[Patent Document 2] Japanese Unexamined Patent Application, First Publication No. 2004-087073

[Patent Document 3] Japanese Unexamined Patent Application, First Publication No. 2007-48344

[Non-Patent Document 1] Japanese Journal of Applied Physics, 46 (2007) p. 3878-3881

[Non-Patent Document 2] Applied Physics Letters, 73 (1998) p. 2078-2080

[Non-Patent Document 3] Japanese Journal of Applied Physics, 44 (2005) p. 3631-3633

### DISCLOSURE OF INVENTION

### Problems to be Solved by the Invention

An object of the present invention is to provide a recordable optical recording medium that performs super resolution reproduction, in which signal processing related to super resolution reproduction can be directly and easily performed without reducing the capacity of the medium, and a method thereof.

### Means for Solving the Problem

An optical recording medium of the present invention and an optical recording reproduction method thereof is such that super resolution reproduction is performed in a structure with a recording layer and a signal reproducing functional layer laminated on a grooved substrate. A length of a mark recorded in a Mark Position method is only one length that is less than the resolution limit in an optical system to be used, and recording marks are formed both on a land and in a groove of the grooved substrate.

The recording layer only allows recording once. The groove cycle, representing a cyclic width between two adjacent grooves, of the grooved substrate is greater than the diffraction limit of the optical system to be used. The signal reproducing functional layer contains Sb or Te.

Moreover, in a structure in which there are laminated an even number of portions comprising the recording layer and the signal reproducing functional layer on the grooved substrate, and there are formed the same number of spiral grooves on one grooved substrate and reversed spiral grooves on the other grooved substrate, signal recording is such that a pair of the spiral groove and the reversed spiral groove can be continuously used for either one of the land and groove of the substrate groove.

### EFFECT OF THE INVENTION

In the present invention, first, recording marks with a length less than the resolution limit are used, and thereby signal components of reproduction other than super resolution reproduction are removed to enable reproduction signal processing only with a signal component for super resolution reproduction. Moreover, based on the super resolution effect in the inter-recording mark sequence direction obtained in this way, land-and-groove recording is performed to thereby obtain an effect of not reducing the capacity of the medium. As a result, there are provided a medium that enables practical application of a super resolution reproduction optical recording medium, and a method thereof.

### BRIEF DESCRIPTION OF THE DRAWINGS

FIG. 1 is an example of a state of a laser light spot when carrying out super resolution reproduction.

FIG. 2 is a configuration example of an optical recording medium for performing super resolution reproduction.

FIG. 3 is a diagram for describing an overview of means according to the present invention.

FIG. 4 is an example of a state of a medium being reproduced, when the means according to the present invention is performed.

FIG. 5 is a diagram showing super resolution reproduction characteristics respectively a) on a land and b) in a groove, in a case where recording was not performed adjacently to the land and groove.

FIG. 6 is a diagram of carrier-to-noise ratio (CNR) measured in super resolution reproduction performed on the land, in a case where recording was performed adjacently to the land and groove.

FIG. 7 is a diagram of carrier-to-noise ratio (CNR) measured in conventional reproduction performed on the land, in a case where recording was performed adjacently to the land and groove.

FIG. 8a) shows a reproduction waveform obtained when the mark position recording was performed in the groove and super resolution reproduction was performed, in a case where recording was not performed adjacently to the land and the groove, FIG. 8b) shows a reproduction waveform obtained when the mark position recording was performed on the land and super resolution reproduction was performed, in a case where recording was not performed adjacently to the land and the groove, and FIG. 8c) shows a reproduction waveform obtained when super resolution reproduction was performed on the land, in a case where the mark position recording was performed adjacently to the land and the groove.

### DESCRIPTION OF THE REFERENCE SYMBOLS

1 Laser light spot
2 Super resolution spot portion
3 Peripheral portion
4 Grooved substrate
5 Protective layer
6 Recording layer
7 Diffusion preventing layer
8 Signal reproducing functional layer
9 Reflecting layer
10 Land
11 Groove
12 Recording mark

### BEST MODE FOR CARRYING OUT THE INVENTION

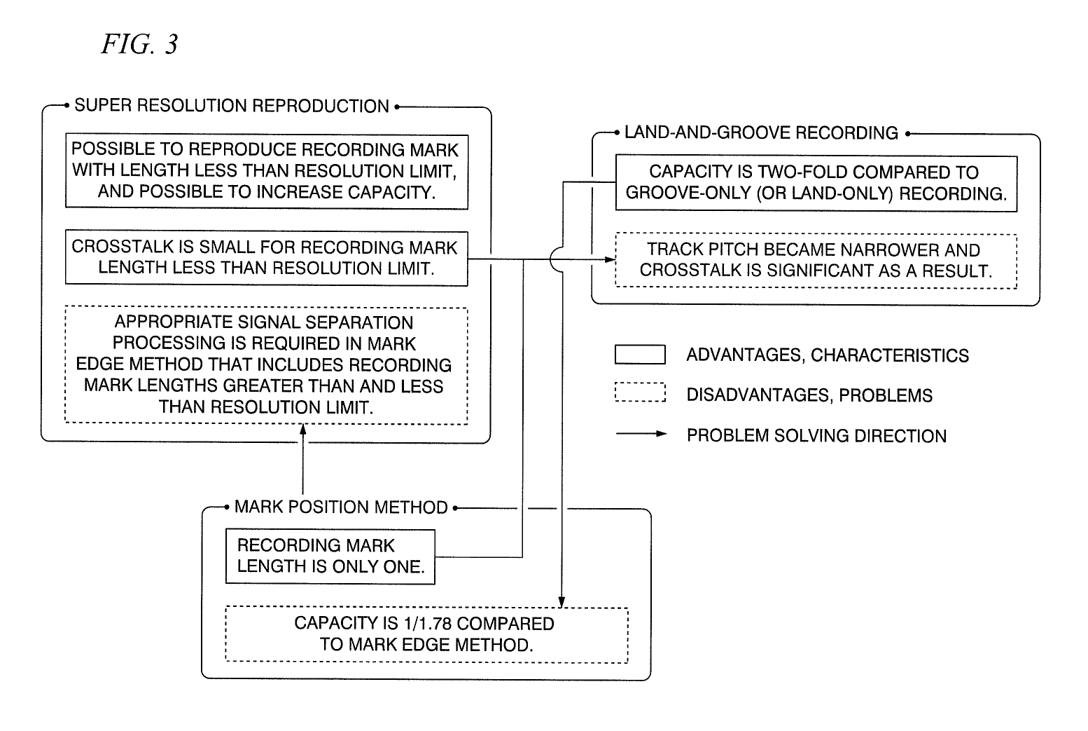

FIG. 3 shows a summarized outline of means according to the present invention. By appropriate use of; super resolution reproduction, land-and-groove recording, and the Mark Position method, respective demerits can be overcome and problems can be resolved. As a result, in addition to its capacity not being reduced, it is possible to directly and easily perform reproduction signal processing by performing super resolution reproduction of recording marks that are less than the resolution limit. Consequently it becomes possible to bring into practical application, an optical recording medium in which a large capacity is achieved by reproduction of recorded marks that are less than the resolution limit, which is a primary characteristic of super resolution reproduction.

As mentioned above, land-and-groove recording enables the capacity to be doubled, however, the distance between the recording mark sequences (track pitch) becomes shorter. Consequently, there is a problem in that superimposition of reproduction signals from the adjacent recording mark sequence (crosstalk) becomes greater. Moreover, there is a single length of the recording marks in the Mark Position method, and therefore if this is set to less than the resolution limit, reproduction signal separation processing becomes unnecessary. However, the capacity becomes 1/1.78 of that in the Mark Edge method, and therefore the merit of performing super resolution reproduction becomes smaller.

On the other hand, in the case of performing super resolution reproduction of a recording mark with its length less than the resolution limit, there is observed an effect of super resolution reproduction in an inter-recording mark sequence direction (medium radial direction), and therefore there is a merit in that crosstalk becomes smaller. Consequently, it is possible to make the track pitch narrower than that conventionally made, and it thereby becomes possible to employ land-and-groove recording. As a result it is possible to double the capacity.

That is to say, in the recording-capable optical recording medium for performing super resolution reproduction, with combined use of the Mark Position method and the land-and-groove recording, the capacity thereof can be increased by approximately 1.12 times than that in the case of recording on the land or in the groove with the Mark Edge method. Therefore, in such a medium and method, the problem of reduced capacity caused by use of the Mark Position method can be resolved.

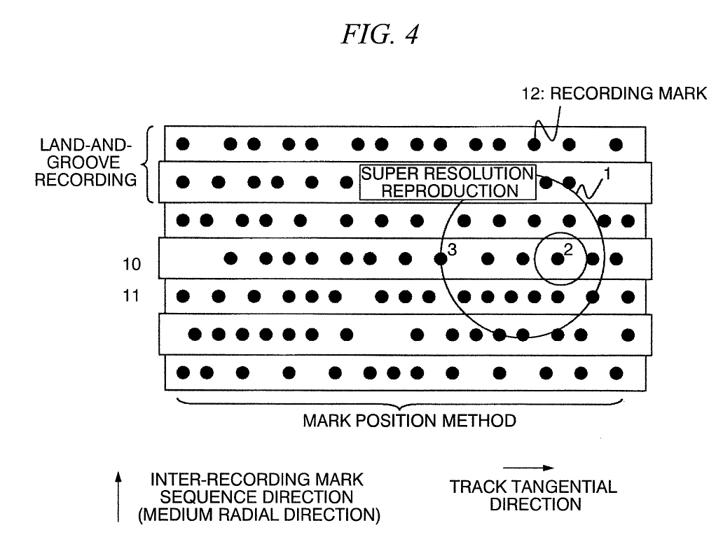

FIG. 4 shows a schematic diagram illustrating an aspect of the medium according to the present invention in a state of being reproduced. Reference symbol 1 denotes a laser light spot, reference symbol 2 denotes a super resolution spot portion, reference symbol 3 denotes a peripheral portion, and reference symbol 12 denotes a recording mark. Only a recording mark within the super resolution spot portion 2 can be reproduced, and recording marks within the peripheral portion 3 including adjacent recording mark sequences are not to be reproduced. In the specification of the present application, it is described that the recording mark length in the Mark Position method has a single length. However, needless to say, an equivalent effect can be attained even when plural lengths are set as the recording mark length, if set lengths are within a range of the length less than the resolution limit.

Use of both of a land 10 and a groove 11 causes necessity of frequent track movements of laser light between the land and the groove. However, in order to enable this to be performed sufficiently in terms of practical use when performing super resolution reproduction on the optical recording medium, the frequency of movements is reduced by using either one of the land 10 and the groove 11 for longer, and it is thereby possible to suppress problems from occurring.

On a grooved substrate there are laminated via a spacer layer or the like for gap adjustment, for example, two media (hereunder, L₀ layer and L₁ layer) that each at least includes a signal reproducing functional layer and a recording layer, and one groove of one grooved substrate in one medium is formed in a spiral shape and the other groove of the other grooved substrate in the other medium is formed in a reversed-spiral shape. In the case where recording is continuously performed from the inner or outer circumference section of the medium, if only the land (or groove) is used, and is used in the order of the L₀ layer and the L₁ layer, the laser light scans in a spiral and a reversed spiral, and then returns to the original radial position. Here, if track movement to the groove (or land) is performed for the first time, and the L₀ layer and the L₁ layer are used in this order, all of the tracks can be used. The track movement is performed once (movement between layers is performed three times) during this time. In this method, there is basically no radial positional movement of the laser light that is performed without recording, and it is therefore suitable for continuous recording. The above L₀ layer and the L₁ layer are taken as a pair and there may be provided with plural forms of these pairs. In this case, the L₀ layer and the L₁ layer do not necessarily have to be adjacent to each other, and the land and the groove do not necessarily have to be used alternately.

### Example 1

FIG. 2 shows a configuration example of a recording-capable optical recording medium for performing super resolution reproduction for implementing the invention of the present application. This comprises; a grooved substrate, a signal reproducing functional layer, a recording layer, a protective layer, a diffusion preventing layer, and a reflecting layer. Material of the grooved substrate is not particularly limited, and glass, plastic, resin, or the like may be used therefor. In the case where recording and reproduction with laser light are not to be performed through the substrate, the substrate may be optically opaque with respect to the laser light.

The preferable groove cycle (distance from the groove to the groove) of the grooved substrate is greater than or equal to the diffraction limit (λ/2 NA) of an optical system to be used, since the laser light needs to scan over the land and the groove.

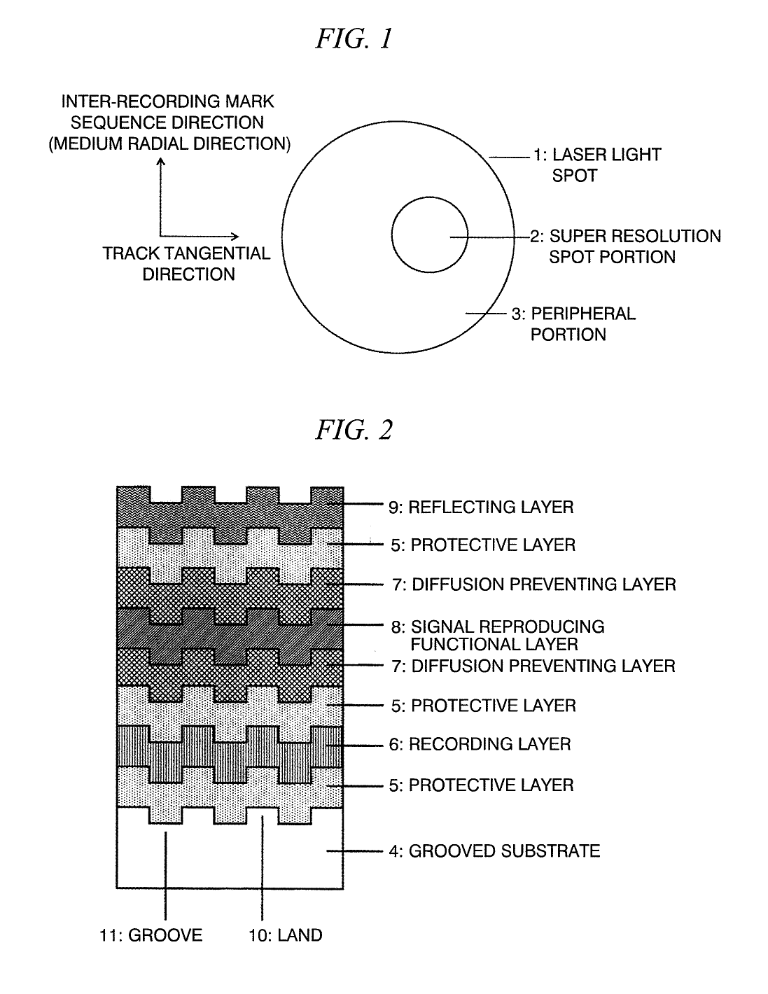

The super resolution spot portion in FIG. 1 is approximately identical in length with the track tangential direction and in the inter-recording mark sequence direction (medium radial direction), and therefore the same super resolution reproduction performance can be obtained in both of the directions. For example, in Non-Patent Document 3, for recording marks less than λ/10 NA arranged along the track tangential direction, there was obtained an excellent result of carrier-to-noise ratio (CNR) of 40 dB. That is to say, it is expected that the groove pitch can be shortened to at least λ/2.5 NA. However, the aforementioned diffraction limit reaches its limit first, and therefore the actual lower limit becomes λ/2 NA. It is preferable that the land height with respect to the groove falls within a range of λ/6 n to λ/8 n (where n denotes the refractive index of the substrate).

It is preferable that the land width and the groove width of the grooved substrate are comparably equal to each other, since marks are recorded respectively thereon. However, for the purpose of resolving characteristic differences related to recording and reproduction, the width ratio may be adjusted.

Basically, in the portion above the grooved substrate in FIG. 2 there may be the signal reproducing functional layer and the recording layer, for super resolution reproduction.

The signal reproducing functional layer may be formed of a material where the optical constant thereof reversibly changes in one portion within the laser light spot, when irradiating the laser light for super resolution reproduction. From the super resolution reproduction characteristic actually obtained, it is preferable to include Sb or Te (in the specification of the present application, this means Sb, Te, or (Sb and Te)), and specific examples thereof include Sb—Te, Ge—Te, Ge—Sb—Te, and Zn—Sb. Moreover these may include Ag, In, Ge and the like as impurities.

It is preferable that the recording layer is formed of a material where laser light irradiation for recording changes the optical constant thereof, and recording formed on the recording layer is not lost when irradiating the laser light for super resolution reproduction.

The protective layer is used to respectively separate and protect; the grooved substrate, the signal reproducing functional layer, and the recording layer. The diffusion preventing layer is used with a purpose of preventing diffusion between the signal reproducing functional layer and the protective layer for example. The reflecting layer adjusts the reflectance from the medium, and also uses a metal with a high thermal conductivity to thereby control temperature distribution within the medium. The protective layer, the diffusion preventing layer, and the reflecting layer may be introduced as required in each application.

### Example 2

As shown in FIG. 2, on the grooved substrate there were formed: a 70 nm protective layer formed with (ZnS)₈₅(SiO₂)₁₅ (that is, ZnS:SiO₂ of ZnS—SiO₂ is 85 mol %:15 mol %); a 4 nm recording layer formed with a composition of platinum oxide (PtOₓ) and SiO₂; a 55 nm protective layer formed with (ZnS)₈₅(SiO₂)₁₅; a 5 nm diffusion preventing layer formed with germanium nitride (Ge—N); a 15 nm signal reproducing functional layer formed with Sb₇₅Te₂₅; a 5 nm diffusion preventing layer formed with Ge—N; a 15 nm protective layer formed with (ZnS)₈₅(SiO₂)₁₅; and a 40 nm reflecting layer formed with alloyed metal of Ag₉₈Pd₁Cu₁, in this order.

The specification of the used grooved substrate was such that it was made of polycarbonate, the groove cycle thereof was 680 nm (the land width and the groove width were equally 340 nm), and the land height with respect to the groove was 39 nm.

For characteristic evaluation of the fabricated optical recording medium, an optical disc tester (DDU-1000 manufactured by Pulstec Industrial Co., Ltd.) with an optical system of λ=405 nm and NA=0.65 was used. Recording and reproduction were both performed at a linear velocity of medium rotation of 2.2 m/s. The duty ratio of the pulse laser light (frequency f) to be irradiated in recording was 50%.

For the optical recording medium formed in this way, 100 nm marks that were less than the resolution limit were recorded at a laser light power of 10.5 mW on the land, and 105 nm marks that were less than the resolution limit were recorded at a laser light power of 9.5 mW in the groove. Recording was made by deformation within the medium due primarily to PtOₓ in the composition of PtOₓ and SiO₂ being decomposed into platinum and oxygen, and it was possible to perform this recording only once.

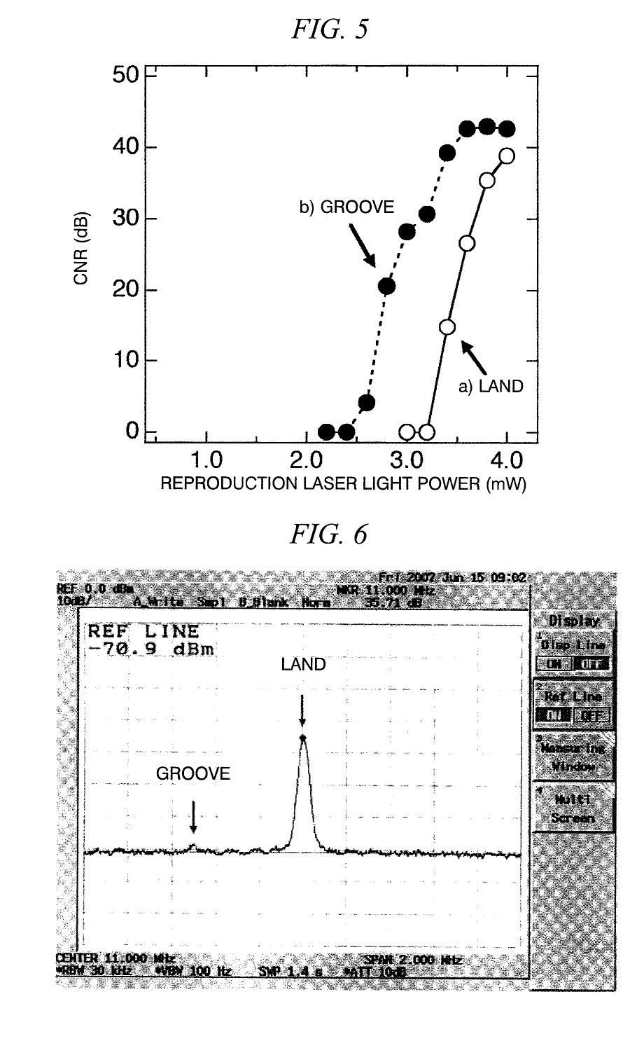

In the case where recording was to be made on the land and no recording was to be made in the adjacent groove, when irradiation was performed on the same land at a laser light power of 4.0 mW, super resolution reproduction with a 38 dB CNR was possible as shown in FIG. 5 (“a” in the diagram).

In the case where recording was to be made in the groove and no recording was to be made on the adjacent land, when irradiation was performed in the same groove at a laser light power of 4.0 mW, super resolution reproduction with a 42 dB CNR was possible as shown in FIG. 5 (“b” in the diagram).

Next, having recorded in the two grooves adjacent to the land, recording was performed on the land sandwiched therebetween, and irradiation was performed at a laser light power of 4.0 mW for reproduction on the same land. As a result, as shown in FIG. 6, the CNR of the land (f=11 MHz) was 35 dB and the CNR from the adjacent grooves (f=10.5 MHz) was 2 dB.

### Comparative Example 1

The optical recording medium, the optical disc tester, the linear velocity condition, and the duty ratio condition were the same as those in the Example 2. 400 nm marks greater than the resolution limit were recorded at a laser light power of 7.0 mW on the land, and 490 nm marks greater than the resolution limit were recorded at a laser light power of 6.7 mW in the groove.

In the case where recording was to be made on the land and no recording was to be made in the adjacent groove, when the laser light power for reproduction was 0.5 mW on the same land, the CNR was 53 dB. In the case where recording was to be made in the groove and no recording was to be made on the adjacent land, when the laser light power for reproduction was 0.5 mW in the same groove, the CNR was 46 dB.

Next, having recorded in the two grooves adjacent to the land, recording was made on the land sandwiched therebetween, and the laser light power for reproduction on the same land was 0.5 mW. As a result, as shown in FIG. 7, the CNR of the land (f=2.75 MHz) was 42 dB and the CNR from the adjacent grooves (f=2.25 MHz) was 41 dB.

In the case of only performing super resolution reproduction in the Example 2, substantially no CNR from the adjacent recording mark sequence was observed and there was no problem of crosstalk. However, in the case of performing conventional reproduction of the Comparative example 1, CNR from the adjacent recording mark sequence was significant and there was a problem of crosstalk. That is to say, if only super resolution reproduction is to be performed, it is possible to narrow the track pitch, and for example, it becomes possible to perform land-and-groove recording without increasing the groove cycle.

### Example 3

Referring to FIG. 2, on the grooved substrate there were formed: a 70 nm protective layer formed with (ZnS)₈₅(SiO₂)₁₅; a 4 nm recording layer formed with PtOₓ; a 60 nm protective layer formed with (ZnS)₈₅(SiO₂)₁₅; a 20 nm signal reproducing functional layer formed with Sb₇₅Te₂₅; a 20 nm protective layer formed with (ZnS)₈₅(SiO₂)₁₅; and a 40 nm reflecting layer formed with alloyed metal of Ag₉₈Pd₁Cu₁, in this order.

The grooved substrate and the optical disc tester were the same as those in the Example 2. The linear velocity at recording and reproduction was 3.0 m/s.

For the optical recording medium formed in this way, recordings were performed in the groove and on the land respectively in the Mark Position methods expressed in formula 1 and formula 2. T in the formulas denote the length 50 nm, the subscript “s” denotes the non-recorded space, and the subscript “m” denotes the recording mark.

$$\begin{matrix}[ Formula 1 ] & \\ {\sum }_{n = 0}^{5} ( 8 {T}_{s} + ( 2 {T}_{m} + 2 {T}_{s} ) \times n + 2 {T}_{m} ) & ( 1 ) \\ [ Formula 2 ] & \\ 8 {T}_{s} + ( 2 {T}_{m} + 2 {T}_{s} ) \times 4 + 2 {T}_{m} & ( 2 )\end{matrix}$$

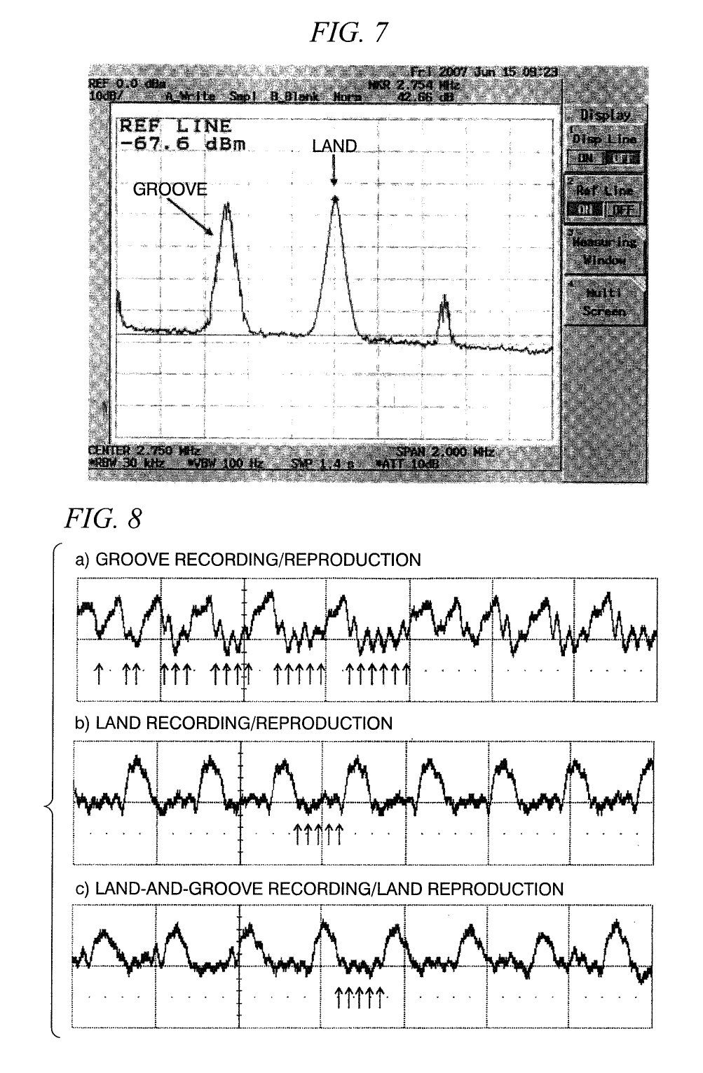

Recordings of the 100 nm mark (2Tₘ), which is less than the resolution limit, present in formula 1 and formula 2 were respectively performed with laser light powers of 9.3 mW and 10.3 mW. In the case where recording was to be made in the groove and no recording was to be made on the adjacent land, when laser light for reproduction was irradiated onto the same groove at 4.0 mW, as shown in FIG. 8a), a reproduction waveform that reproduces formula 1 was observed.

In the case where recording was to be made on the land and no recording was to be made in the adjacent groove, when laser light power for reproduction was irradiated onto the same land at 4.0 mW, as shown in FIG. 8b), a reproduction waveform that reproduces formula 2 was observed.

Next, having recorded in the two grooves adjacent to the land, recording was performed on the land sandwiched therebetween, and then laser light power for reproduction was irradiated onto the same land at 4.0 mW. As a result, as shown in FIG. 8c), a reproduction waveform that reproduces formula 2 was observed.

The reproduction waveform of FIG. 8c) is substantially equivalent to that of FIG. 8b), and the waveform of FIG. 8a) is not superposed. That is to say, in the Mark Position method in which recording marks of a length less than the resolution limit are used, even if land-and-groove recording is performed, there will be substantially no actual crosstalk.

1. An optical recording medium for performing super resolution reproduction, in which a recording layer and a signal reproducing functional layer are laminated on a grooved substrate, wherein
a length of a mark recorded in a Mark Position method is only one length that is less than the resolution limit in an optical system to be used; and
recording marks are formed both on a land and in a groove of the grooved substrate.

2. An optical recording medium for performing super resolution reproduction according to claim 1, wherein recording is possible only once on the recording layer.

3. An optical recording medium for performing super resolution reproduction according to claim 1, wherein a groove cycle of the grooved substrate is greater than or equal to a diffraction limit of an optical system to be used.

4. An optical recording medium for performing super resolution reproduction according to claim 1, wherein the signal reproducing functional layer contains Sb or Te.

5. An optical recording medium for performing super resolution reproduction according to claim 1, wherein in a structure in which there are laminated an even number of portions comprising the recording layer and the signal reproducing functional layer on the grooved substrate, and there are formed the same number of spiral grooved substrates and reversed spiral grooved substrates, signal recording is such that a pair of the spiral groove and the reversed spiral groove are continuously used for either one of the land and groove of the grooved substrate.

6. An optical recording reproduction method of an optical recording medium for performing super resolution reproduction, in which a recording layer and a signal reproducing functional layer are laminated on a grooved substrate, wherein
a length of a mark recorded in a Mark Position method is only one length that is less than the resolution limit in an optical system to be used; and
recording marks are formed both on a land and in a groove of the grooved substrate.

7. An optical recording reproduction method for performing super resolution reproduction according to claim 6, wherein recording is possible only once on the recording layer.

8. An optical recording reproduction method for performing super resolution reproduction according to claim 6, wherein a groove cycle of the grooved substrate is greater than or equal to a diffraction limit of an optical system to be used.

9. An optical recording reproduction method for performing super resolution reproduction according to claim 6, wherein the signal reproducing functional layer contains Sb or Te.

10. An optical recording reproduction method for performing super resolution reproduction according to claim 6, wherein in a structure in which there are laminated an even number of portions comprising the recording layer and the signal reproducing functional layer on the grooved substrate and there are formed the same number of spiral grooved substrates and reversed spiral grooved substrates, signal recording is such that a pair of the spiral groove and the reversed spiral groove are continuously used for either one of the land and groove of the substrate groove.
